(19) United States
(12) Patent Application Publication
(10) Pub. No.: US 2014/0053982 A1
(43) Pub. Date: Feb. 27, 2014

(54) METHOD AND APPARATUS FOR PROCESSING WAFER-SHAPED ARTICLES

(71) Applicants: Karl-Heinz HOHENWARTER, DELLACH/GAIL (AT); Reinhold SCHWARZENBACHER, KOLBNITZ (AT)

(72) Inventors: Karl-Heinz HOHENWARTER, DELLACH/GAIL (AT); Reinhold SCHWARZENBACHER, KOLBNITZ (AT)

(73) Assignee: LAM RESEARCH AG, VILLACH (AT)

(21) Appl. No.: 13/593,298

(22) Filed: Aug. 23, 2012

(51) Int. Cl. B44C 1/22; F17D 1/00

(52) U.S. Cl. 156/345.15; 156/345.23; 34/444

(57) ABSTRACT

An apparatus and method for processing wafer-shaped articles features a spin chuck that is axially displaceable between at least two exhaust levels within a surrounding collector. A gas supply system comprises ducts for supplying gas separately to a first interior region of the collector that is above the spin chuck and a second interior region that is below the spin chuck. The pressure differential within the collector above and below the spin chuck can thereby be controlled to prevent cross-contamination between collector levels.

### BACKGROUND OF THE INVENTION

1. Field of the Invention

The invention relates to a device and a method for processing wafer-shaped articles, such as semiconductor wafers, flat panel displays or optical discs.

2. Description of Related Art

Semiconductor wafers are subjected to various surface treatment processes such as etching, cleaning, polishing and material deposition. To accommodate such processes, a single wafer may be supported in relation to one or more treatment fluid nozzles by a chuck associated with a rotatable carrier, as is described for example in U.S. Pat. Nos. 4,903,717 and 5,513,668.

U.S. Pat. No. 4,903,717 discloses that its spin-chuck may be raised and lowered relative to a surrounding liquid collector that has plural liquid collecting levels and a common exhaust for collecting gas from the interior of the liquid collector.

U.S. Pat. No. 7,837,803 discloses an improved liquid and gas collector in which the exhaust at each of the levels may be individually controlled via valves provided at each of the levels. However, depending upon the particular process being performed upon the wafer-shaped article, the valves of that patent will come in contact with chemically aggressive fumes. It can be difficult to maintain such valves in good working order under such conditions.

There is therefore a need for a collector structure that can better prevent fumes from various media (e.g., acid, base, organic) from intermingling in a common process chamber, so as to prevent vapor cross-contamination. Such cross-contamination could result in the deposition of crystalline solids on delicate processing equipment, as well as various safety issues.

### SUMMARY OF THE INVENTION

The invention in one aspect thus pertains to an apparatus for processing wafer-shaped articles, comprising a spin chuck for holding and rotating a wafer-shaped article about a rotation axis. The spin chuck is displaceable along the rotation axis between at least two positions. At least one liquid dispenser supplies liquid to a rotating wafer-shaped article when mounted on the spin chuck. A collector surrounds the spin chuck, and has at least two exhaust levels for exhausting gas from an interior of the collector, the at least two exhaust levels corresponding to the at least two positions of the spin chuck. A gas supply system supplies gas to an interior of the collector, and comprises ducts for supplying gas separately to a first interior region above the spin chuck when the spin chuck is positioned in one of its at least two positions and a second interior region below the spin chuck when the spin chuck is positioned in that same one of its at least two positions.

In preferred embodiments of the apparatus according to the present invention, the ducts comprise separately controllable valves so that gas flows to the first and second interior regions can be controlled independently of one another.

In preferred embodiments of the apparatus according to the present invention, the spin chuck is displaceable along said rotation axis between at least three positions, and wherein said collector has at least three exhaust levels corresponding to said at least three positions of said spin chuck.

In preferred embodiments of the apparatus according to the present invention, said spin chuck is displaceable along said rotation axis between at least four positions, and wherein said collector has at least four exhaust levels corresponding to said at least four positions of said spin chuck.

In preferred embodiments of the apparatus according to the present invention, the collector comprises a gas distribution plate positioned above and overlying the spin chuck.

In preferred embodiments of the apparatus according to the present invention, said valves are manually controlled.

In preferred embodiments of the apparatus according to the present invention, said valves are automatically controlled.

In preferred embodiments of the apparatus according to the present invention, pressure sensors are positioned in said first and second regions, said valves being automatically controlled based upon readings of said pressure sensors.

In preferred embodiments of the apparatus according to the present invention, a shutter is positioned in an uppermost exhaust level of said collector.

In preferred embodiments of the apparatus according to the present invention, said shutter is automatically controlled so as to open in response to said spin chuck being displaced to said uppermost exhaust level, and to close when said spin chuck is displaced to a lower exhaust level of said collector.

In preferred embodiments of the apparatus according to the present invention, each of said valves comprises at least three flow settings.

In preferred embodiments of the apparatus according to the present invention, said valves are controlled such that a relatively greater gas flow is provided to said first region and a relatively lesser gas flow is provided to said second region, when said spin chuck is positioned at a lower one of said at least two exhaust levels, and a relatively lesser gas flow is provided to said first region and a relatively greater gas flow is provided to said second region, when said spin chuck is positioned at a lower one of said at least two exhaust levels.

In another aspect, the present invention relates to a method for processing wafer-shaped articles, comprising positioning a wafer-shaped article on a spin chuck that is surrounded by a collector, displacing said spin chuck vertically so as to position the spin chuck and the wafer-shaped article at a first level within said collector, supplying gas interiorly of said collector separately at a first flow rate to a first region above the wafer shaped article and at a second flow rate to a second region below the wafer-shaped article, displacing the spin chuck vertically so as to move the spin chuck to a second level within the collector that is above the first level, and supplying gas interiorly of said collector separately at a third flow rate to a third region above the wafer shaped article and at a fourth flow rate to a fourth region below the wafer-shaped article, wherein the first flow rate is greater than the third flow rate, and wherein the second flow rate is less than the fourth flow rate.

In preferred embodiments of the method according to the present invention, ambient pressure is measured in each of the first and second regions, and the first and second flow rates are controlled such that a pressure differential between said first and second regions is maintained at less than a predetermined value.

In preferred embodiments of the method according to the present invention, the wafer-shaped article is loaded and unloaded at an uppermost level within the collector, while keeping open a shutter provided in the uppermost level of the collector.

In preferred embodiments of the method according to the present invention, an ambient pressure outside of the collector is monitored, and the first and second flow rates are controlled such that a pressure differential between the ambient pressure outside of the collector and each of said first and second regions is maintained at less than a predetermined value.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 shows a schematic side view of an apparatus according to the prior art, with the chuck in a first position;

FIG. 2 shows a schematic side view of the apparatus of FIG. 1, with the chuck in a second position;

FIG. 3 shows a schematic side view of an apparatus according to a preferred embodiment of the present invention, with the chuck in a first position;

FIG. 4 shows a schematic side view of an apparatus according to a preferred embodiment of the present invention, with the chuck in a second position;

FIG. 5 shows a schematic side view of an apparatus according to a preferred embodiment of the present invention, with the chuck in a third position; and

FIG. 6 shows a schematic side view of an apparatus according to a preferred embodiment of the present invention, with the chuck in a fourth position.

### DETAILED DESCRIPTION

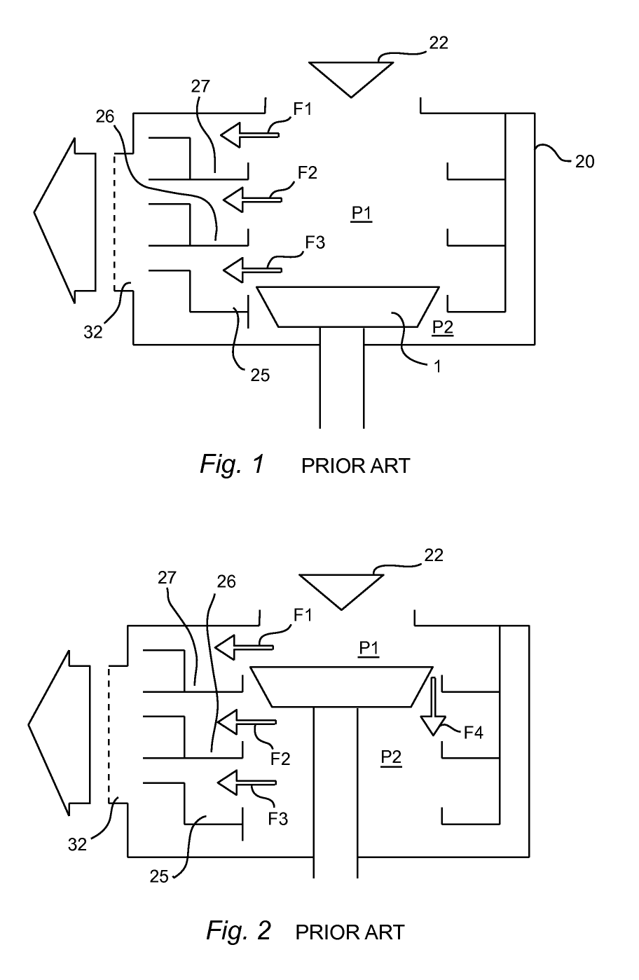

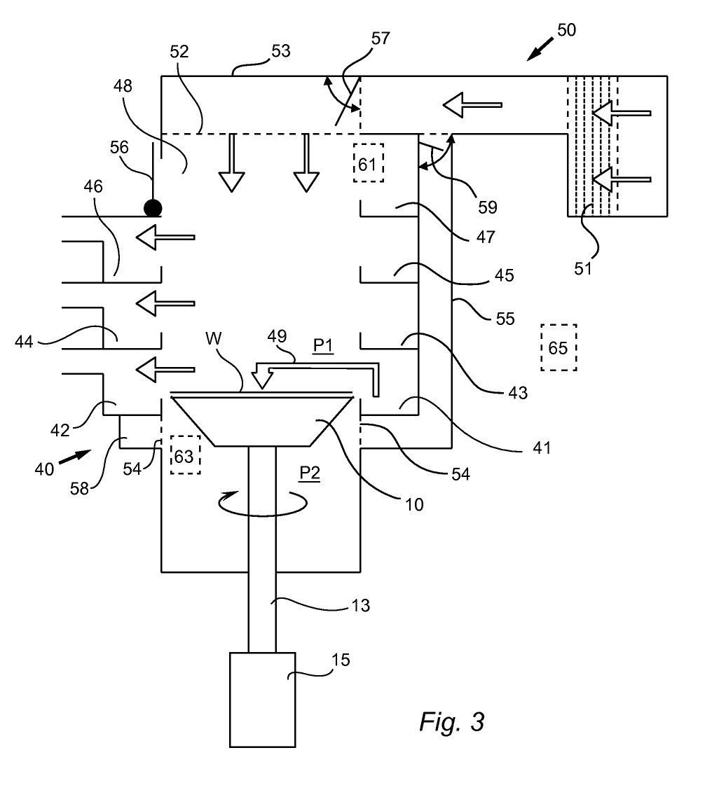

FIG. 1 shows a device like that of FIG. 3 of U.S. Pat. No. 4,903,717. Gases within collector 20 are withdrawn through ducts 25, 26, 27 via a common outlet 32. When chuck 1 is at its lowermost position as depicted in FIG. 1, this poses no particular problem, as the gases are withdrawn from above the chuck 1 in the direction of arrows F1, F2 and F3, and the pressure P1 prevailing above the chuck tends to equalize with the pressure P2 prevailing below the chuck.

However, when the chuck 1 is raised to one of its upper level positions as shown in FIG. 2, the continued exhausting of gas not only above the chuck along arrow F1 but also below the chuck along arrows F2 and F3 has been found to cause the pressure P2 prevailing below the chuck 1 to become significantly less than the pressure P1 prevailing above the chuck 1. That pressure differential provokes an undesired flow of gas from the current level of the chuck to one or more of the lower levels, as shown schematically by the arrow F4. That undesired gas flow can in turn entrain process liquids dispensed through liquid dispenser 22 or vapors being utilized in the current process level, giving rise to cross-contamination of one or more of the lower process levels.

Turning now to FIG. 3, in a preferred embodiment of a method and apparatus according to the present invention, a spin chuck 10 is surrounded by a collector 40. Collector 40 in this embodiment has four exhaust levels 42, 44, 46 and 48, of which levels 42, 44 and 46 are process levels whereas level 48 is utilized for loading a wafer W onto the chuck 10 and unloading the processed wafer W therefrom. At each of these exhaust levels there is preferably a corresponding drain 41, 43, 45, 47 for recovering process liquids from the surface of the wafer W. The arrangement of the drains and gas exhausts of the collector may be as further described for example in commonly-owned copending application US Pub. No. 2012/0103522 A1.

Wafer W is preferably a semiconductor wafer and chuck is preferably a component of a single-wafer wet processing tool for such semiconductor wafers. As those skilled in the art are aware, such chucks are designed to receive a wafer W of a specified diameter, with examples being 200 mm, 300 mm and 450 mm.

Spin chuck 10 is shown as being rotated by motor 15 via shaft 13, and this drive also serves to displace the spin chuck 10 axially between each of the four collector levels. Such a spin chuck may comprise a series of gripping pins (not shown) for holding a wafer W at its edge, or may support a wafer W on a cushion of flowing gas by implementation of the Bernoulli principle as described in U.S. Pat. No. 4,903,717. Chuck 10 could alternatively take the form of a magnetic rotor that is rotated and displaced axially via a surrounding stator, as described for example in commonly-owned co-pending U.S. application Pub. No. 2012/0018940.

At least one liquid dispenser 49 is provided. In this embodiment, a liquid dispenser is provided at each of the three process levels, although only the lowermost liquid dispenser 49 is illustrated in FIG. 3 for ease of understanding. Each liquid dispenser 49 is preferably pivotable between a home position in which it does not obstruct vertical movement of the spin chuck 10 between collector levels, and a dispensing position as shown in FIG. 3. Liquid dispensers of this type are further described for example in commonly-owned copending application US Pub. No. 2012/0103522 A1.

The apparatus of this embodiment also includes a gas supply system 50, which is preferably based upon a filter fan unit 51 designed to provide particle-free air (or extremely low particle air) to the interior of collector 40. Other gases than air can be supplied through the filter fan unit 51, for example nitrogen or air that is enriched in nitrogen and correspondingly impoverished of oxygen. Downstream of filter fan unit 51 the gas flow is divided between an upper duct 53 and a lower duct 55. A respective control valve 57, 59 is associated with each of these ducts 53, 55. Elements 57, 59 may for example be butterfly valves. Furthermore, although elements 57, 59 are referred to herein as “valves”, it is to be understood that in this context that term encompasses other structures for controlling the rate of gas flow to the ducts 53, 55, such as adjustable shutters, vents and the like.

Duct 53 preferably terminates in a gas showerhead 52, such as that described for example in U.S. Pat. No. 6,715,943. Duct 55 leads into an annular pressure distribution chamber 58, from which gas is upplied into the wafer ambient via lateral distribution plate 54. Also visible in FIG. 3 is a shutter 56 provided in the uppermost exhaust level 48 of collector 40, which, being the loading and unloading level and not a process level, need not be equipped with an exhaust duct.

Spin chuck 10 is in its lowermost position in FIG. 3, at which position the pressures P1 and P2 will tend to equalize similar to the situation described in connection with FIG. 1. That equalization of pressures is promoted according to this embodiment of the invention, however, by appropriate selection of the flow rates of gas through valves 57 and 59. In particular, in the position shown in FIG. 3, the upper valve 57 is preferably fully open, whereas the lower valve 59 is preferably nearly closed. Shutter 56 is fully closed in this configuration. That combination of valve positions will best promote approximate equality between the ambient pressures P1 and P2 above and below the chuck 10, respectively.

Valves 57, 59 thus preferably each have at least three open positions, corresponding to low, moderate and high rates of flow, or stated differently, nearly closed, partly open and fully open. The state of valves 57, 59 can be changed manually is some embodiments, but in more preferred embodiments the valves 57, 59 are set autoamtically based upon detecting the position of chuck 10 at one of the four exhaust levels, or based upon an ambient pressure measurement, or based upon a combination of these parameters.

Further precision in controlling the pressures P1 and P2 can be achieved by the use of pressure sensors 61, 63, which detect ambient pressure inside the collector 40 in the regions above and below the chuck, respectively. If the detected pressures differ from one another by more than a predetermined threshold, for example about 5 Pa, then the flow rate through one or both of valves 57, 59 is adjusted until the pressure difference falls below that threshold, and the ongoing monitoring of the ambient pressures P1 and P2 and associated control of valves 57, 59 maintains the pressure differential below the chosen threshold.

The apparatus may also be equipped with an external ambient pressure sensor 65, with valves 57, 59 being controlled to maintain the difference between each of pressures P1 and P2 and the external ambient pressure within a predetermined limit, for example about 5 Pa.

In case of using pressure sensors 61, 63 and optionally 65, valves 57, 59 preferably have a much greater number of positions, inclusive of valves whose degree of opening is continuously variable.

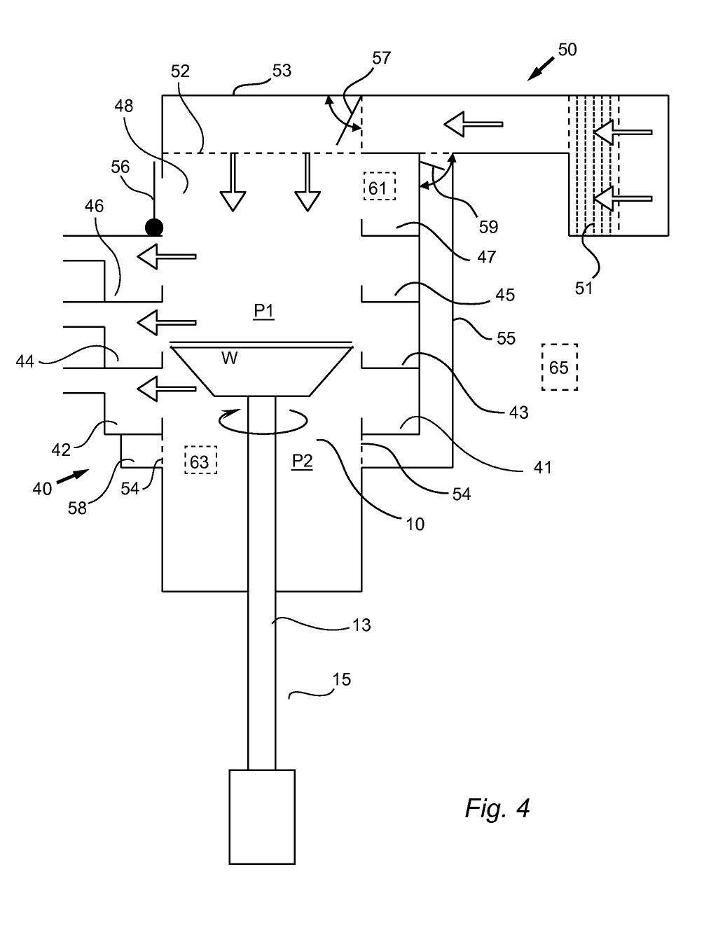

Referring now to FIG. 4, the spin chuck 10 has been raised from exhaust level 42 to exhaust level 44. In this position, pressures P1 and P2 are best equalized by opening valve 59 more fully and closing valve 57 somewhat, relative to the positions of those valves when spin chuck was at the exhaust level 42 in FIG. 3. In particular, valves 57 and 59 are preferably each changed to their respective moderate flow setting in response to movement of the spin chuck from exhaust level 42 to exhaust level 44, whereafter more precise control of pressures P1 and P2 can if desired be achieved through monitoring with and feedback from the pressure sensors 61, 63 and optionally 65. Shutter 56 remains closed while spin chuck 10 is in this position.

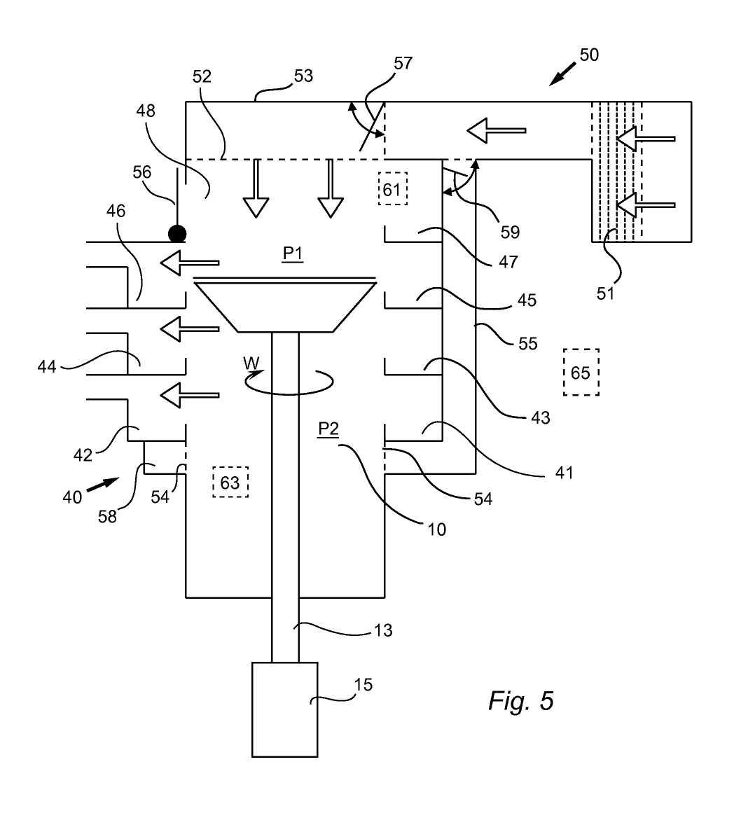

In FIG. 5, the spin chuck 10 has been raised from exhaust level 44 to exhaust level 46. In this position, pressures P1 and P2 are best equalized by opening valve 59 to its fully open or high flow setting, and closing valve 57 to a greater extent, to its low flow rate position, relative to the positions of those valves when spin chuck was at the exhaust level 44 in FIG. 4. Valves 57 and 59 are preferably each automatically changed to those settings in response to movement of the spin chuck from exhaust level 44 to exhaust level 46, whereafter more precise control of pressures P1 and P2 can if desired be achieved through monitoring with and feedback from the pressure sensors 61, 63 and optionally 65. Shutter 56 remains closed while spin chuck 10 is in this position.

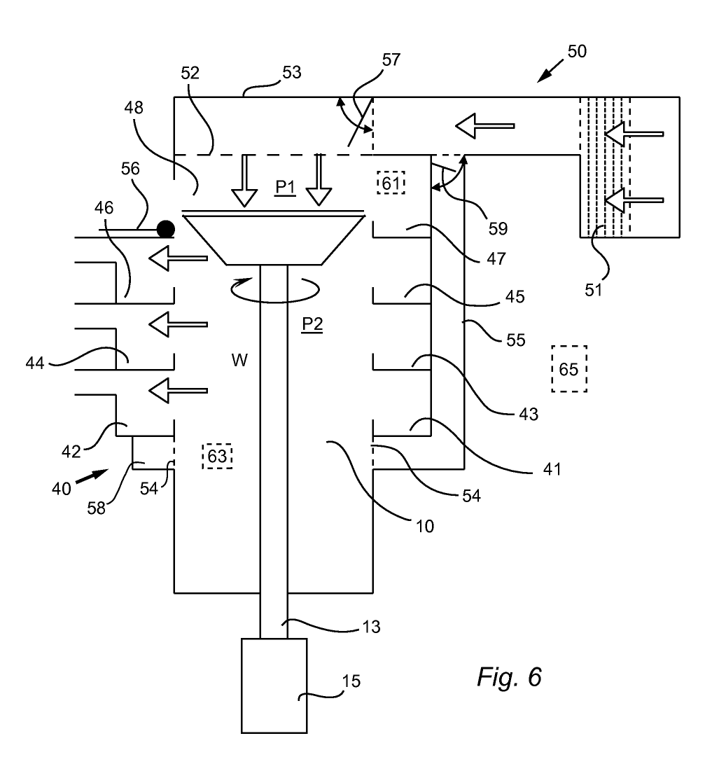

Finally, in FIG. 6, the spin chuck 10 has been raised from exhaust level 46 to the loading/unloading level 48. In this position, pressures P1 and P2 are best equalized by keeping valve 59 at its fully open or high flow setting, and keeping valve 57 at its low flow rate position, i.e., in the same or approximately the same positions as in FIG. 5. In this case, however, the shutter 56 is opened, as shown in FIG. 6. Thereafter, more precise control of pressures P1 and P2 can if desired be achieved through monitoring with and feedback from the pressure sensors 61, 63 and optionally 65.

Although the invention has been described in connection with several preferred embodiments in the foregoing description, it will be appreciated by those skilled in the art that various modifications are possible without departing from the true scope and spirit of the invention as disclosed herein and as set forth in the appended claims.

What is claimed is:

1. Apparatus for processing wafer-shaped articles, comprising:
a spin chuck for holding and rotating a wafer-shaped article about a rotation axis, said spin chuck being displaceable along said rotation axis between at least two positions;
at least one liquid dispenser for supplying liquid to a rotating wafer-shaped article when mounted on said spin chuck;
a collector surrounding said spin chuck, said collector having at least two exhaust levels for exhausting gas from an interior of said collector, said at least two exhaust levels corresponding to said at least two positions of said spin chuck; and
a gas supply system for supplying gas to an interior of said collector, said gas supply system comprising ducts for supplying gas separately to a first interior region above said spin chuck when said spin chuck is positioned in one of said at least two positions and a second interior region below said spin chuck when said spin chuck is positioned in said one of said at least two positions.

2. The apparatus according to claim 1, wherein said ducts comprise separately controllable valves so that gas flows to said first and second interior regions can be controlled independently of one another.

3. The apparatus according to claim 1, wherein said spin chuck is displaceable along said rotation axis between at least three positions, and wherein said collector has at least three exhaust levels corresponding to said at least three positions of said spin chuck.

4. The apparatus according to claim 1, wherein said collector comprises a gas distribution plate positioned above and overlying said spin chuck.

5. The apparatus according to claim 2, wherein said valves are manually controlled.

6. The apparatus according to claim 2, wherein said valves are automatically controlled.

7. The apparatus according to claim 6, further comprising pressure sensors positioned in said first and second regions, said valves being automatically controlled based upon readings of said pressure sensors.

8. The apparatus according to claim 1, further comprising a shutter positioned in an uppermost exhaust level of said collector.

9. The apparatus according to claim 8, wherein said shutter is automatically controlled so as to open in response to said spin chuck being displaced to said uppermost exhaust level, and to close when said spin chuck is displaced to a lower exhaust level of said collector.

10. The apparatus according to claim 2, wherein each of said valves comprises at least three flow settings.

11. The apparatus according to claim 2, wherein said valves are controlled such that a relatively greater gas flow is provided to said first region and a relatively lesser gas flow is provided to said second region, when said spin chuck is positioned at a lower one of said at least two exhaust levels, and a relatively lesser gas flow is provided to said first region and a relatively greater gas flow is provided to said second region, when said spin chuck is positioned at a lower one of said at least two exhaust levels.

12. Method for processing wafer-shaped articles, comprising:
positioning a wafer-shaped article on a spin chuck surrounded by a collector;
displacing said spin chuck vertically so as to position the spin chuck and the wafer-shaped article at a first level within said collector;
supplying gas interiorly of said collector separately at a first flow rate to a first region above the wafer shaped article and at a second flow rate to a second region below the wafer-shaped article;
displacing the spin chuck vertically so as to move the spin chuck to a second level within the collector that is above the first level; and
supplying gas interiorly of said collector separately at a third flow rate to a third region above the wafer shaped article and at a fourth flow rate to a fourth region below the wafer-shaped article;
wherein the first flow rate is greater than the third flow rate, and wherein the second flow rate is less than the fourth flow rate.

13. The method according to claim 12, further comprising measuring ambient pressure in each of the first and second regions, and controlling said first and second flow rates such that a pressure differential between said first and second regions is maintained at less than a predetermined value.

14. The method according to claim 12, further comprising loading and unloading the wafer-shaped article at an uppermost level within the collector, while keeping open a shutter provided in the uppermost level of the collector.

15. The method according to claim 12, further comprising monitoring an ambient pressure outside of the collector, and controlling said first and second flow rates such that a pressure differential between the ambient pressure outside of the collector and each of said first and second regions is maintained at less than a predetermined value.
